(19) United States
(12) Patent Application Publication
(10) Pub. No.: US 2004/0030861 A1
(43) Pub. Date: Feb. 12, 2004

(54) Customizable computer system

(76) Inventors: Bart Plackle, Diest (BE); Kurt Herremans, Hasselt (BE)

Correspondence Address: BROMBERG & SUNSTEIN LLP, 125 SUMMER STREET, BOSTON, MA, 02110-1618, US

(21) Appl. No.: 10/609,141

(22) Filed: Jun. 27, 2003

Related U.S. Application Data
(60) Provisional application No. 60/392,344, filed on Jun. 27, 2002.

(51) Int. Cl. G06F 15/00; G06F 15/76

(52) U.S. Cl. 712/32

(57) ABSTRACT

A customizable computing system, having a microprocessor and a programmable logic device coupled to the microprocessor via a dedicated bus. The programmable logic device includes a configuration to provide I/O functionality to the system and may be a field programmable gate array. The programmable logic device operates as both a north bridge and a south bridge as is understood by those of ordinary skill in the art. Requests are received from the microprocessor in the programmable logic device over the dedicated bus and are processor specific requests. The processor specific requests are translated into processor dependent commands by a bridge. After the processor specific requests are translated into processor dependent commands, the commands are forwarded to processor independent I/O structures which interface with both internal and external peripheral devices to the customizable computing system.

### CROSS-REFERENCE TO RELATED APPLICATION

This U.S. patent application claims priority from provisional patent application Serial No. 60/392,344 filed on Jun. 27, 2002 entitled “Customizable Computer System” and bearing attorney docket 2684/102 which is incorporated herein by reference in its entirety.

### TECHNICAL FIELD AND BACKGROUND ART

The present invention relates to computer systems and more specifically to embedded computer systems.

It is known in the prior art to integrate the functionality of an electronic system on a single chip, which is commonly referred to as a system on chip (SoC). In such a chip, a processor is designed along with the other required components, including memory, memory controllers, video controllers, and input and output interfaces. Such designs allow for custom tailored functionality and can provide high speed processing. One problem with such designs is their time consuming development cycle since each component is custom designed. Further, once the chip is made in silicon it cannot be altered. Thus, the design needs to be carefully verified before production begins. Additionally, as the markets change and new I/O interfaces are developed, an SoC cannot be reconfigured to accommodate the new interfaces.

It is also known in the art to use field programmable gate arrays (FPGAs) to create a computer system. Although manufactures of FPGAs have created an embedded processor core structure, which may be programmed to create a processor, such designs have poor performance due to limited processor speeds and limited cache and memory bandwidth. It would therefore be desirable to have a system which is customizable to allow for additions or corrections to the configuration, but which maintains a relatively high processing rate similar to integrated SoCs.

### SUMMARY OF THE INVENTION

In a first embodiment of the invention there is provided a customizable computing system, having a microprocessor and a programmable logic device coupled to the microprocessor via a dedicated bus. The microprocessor and the programmable logic device may be integrated within the same physical package, but are separate components. In some embodiments, the dedicated bus includes a request path that is 32 bits wide. The programmable logic device includes a configuration to provide I/O functionality to the system and may be a field programmable gate array. The programmable logic device operates as both a north bridge and a south bridge as is understood by those of ordinary skill in the art. The system further includes a system port coupled to the programmable logic device. In another embodiment, the system further includes a second bus coupled to the programmable logic device, wherein the system port is coupled to the second bus. The system may also have a plurality of ports coupled to the gate array and the ports may be coupled to the second bus.

The programmable logic device may include a configuration to serve as a bridge between the dedicated bus and the system port. The configuration may also serve as a bridge between the dedicated bus and the second bus. The programmable logic device may further include a configuration to provide a hardware video display driver.

In yet another embodiment the programmable logic device includes logic which is microprocessor specific and logic which is microprocessor independent.

The system may also include a configuration that serves as a bridge between the functionality that is independent of the specific type of microprocessor and the functionality that is specific for the specific type of microprocessor.

In an embodiment, the microprocessor is of a type employing a RISC instruction set, such instruction set being at least 32 bits wide. In other embodiments, the microprocessor may be an ARM microprocessor. In still further embodiments, the microprocessor provides performance at least equal to that of an Intel Xscale 80200 model microprocessor. The microprocessor may be of a type permitting operation of at least 500 MIPS and the system has a fully operational performance-to-power ratio of at least 300 MIPS per watt. In certain embodiments, the microprocessor has an architecture permitting pipeline processing of at least four simultaneously outstanding operations and the dedicated bus and programmable logic device are configured to support such pipeline processing.

The system may further include random access memory of at least 64 megabytes coupled to the microprocessor. The random access memory may also be coupled to the video display driver and the video display driver may share the memory with the microprocessor. The random access memory may be accessible over the dedicated bus.

### BRIEF DESCRIPTION OF THE DRAWINGS

The foregoing features of the invention will be more readily understood by reference to the following detailed description, taken with reference to the accompanying drawings, in which:

FIG. 1 is one embodiment of a customizable computer system;

FIG. 2 shows the flow of instructions and data between the microprocessor, the programmable logic device, and memory;

FIG. 3 shows the request and data path connections between the microprocessor, the memory and the programmable logic device; and

FIG. 4 is a block diagram showing the bridge mechanism and the translation of processor dependent commands to processor independent commands for use on a peripheral bus or an APB bus.

### DETAILED DESCRIPTION OF SPECIFIC EMBODIMENTS

Definitions. As used in this description and the accompanying claims, the following terms shall have the meanings indicated, unless the context otherwise requires: It should be understood that the term “bus” implies a signal line, which may be either a data line for sending data signals or an instruction/request line for sending instruction signals which may include one or more address locations. The term “dedicated bus” shall mean a bus that connects a microprocessor and one logic device. A dedicated bus transmits processor-dependent request signals. The term “I/O interface” shall mean a device which is part of the programmable logic device and which is in communication with the bridge and provides an interface to an external peripheral device or an internal peripheral device. The term “RISC” shall mean a reduced instruction set computer as is commonly understood. The term MIPS (millions of instructions per second) shall be defined according to the Dhrystone 2.1 benchmark. The term “fully operational” shall mean that peak power is consumed. The term “ARM” (advanced RISC machine) shall be used in its ordinary context.

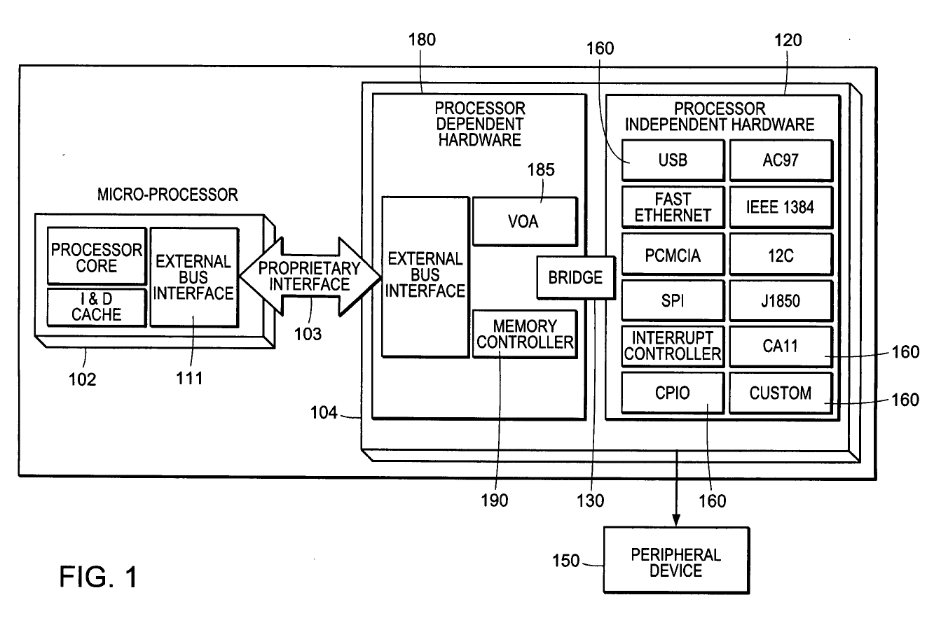

FIG. 1 is one embodiment of a customizable computer system 100. Such a customizable computer system may be implemented as an embedded system in a device such as a cable television set-top box, firewall/router, residential gateway, for example. The customizable computer system 100 includes a microprocessor 102, such as the Intel 80200 produced by the Intel Corporation, and also includes a programmable logic device 104. The microprocessor 102 may employ a RISC instruction set wherein the instruction set is at least 32 bits wide. In one embodiment, the microprocessor is an ARM microprocessor-permitting pipeline processing of at least four simultaneously outstanding operations.

The microprocessor 102 and the programmable logic device 104 are coupled together via a dedicated bus 103. The programmable logic device 104 receives signals into an external bus interface 110 on the dedicated bus 103 for instruction signals from the external bus interface 111 of the microprocessor. The microprocessor sends the instruction signal on the bus using a microprocessor specific instruction. The microprocessor multiplexes address and control signals onto the dedicated bus. The programmable logic device 104 includes a configuration to provide input and output (I/O) functionality 160 to the system. The programmable logic device 104 may be constructed from a field programmable gate array in one embodiment. The programmable logic device 104 includes bridge 130 for transferring the instruction signal from the external bus interface 110 onto an appropriate internal bus (Not Shown). For example, if the microprocessor 102 is attempting to send an instruction to send data to a peripheral I/O device 150, the external bus interface 110 receives the instruction on the dedicated bus 103 and the data is transferred on a separate data bus that is controlled and kept in sync with the commands on the dedicated bus by a memory controller 190. The data and instruction signals are provided to the bridge 130 which translates the signal and directs the data to a peripheral device bus, or to an APB (Advanced Peripheral Bus).

The programmable logic device 104 provides a generic processor interface 120 by translating through the bridge processor 130 specific instructions into a generic instruction set. As such, instructions are passed through the dedicated bus 103 to an external bus interface 110. The external bus interface 110 is electrically coupled to the bridge 130, which provides the generic instructions to the processor independent hardware 120. For example, such processor independent hardware may include various I/O device interfaces 160 such as, for example, USB, IEEE1394, and PCMCIA. The processor dependent hardware 180 includes both a video controller 185 and a memory controller 190. The video controller provides video processing of graphical information from the microprocessor and shares memory with the microprocessor through the memory controller 190. The translation of the processor specific interface to a generic interface affords system designers many benefits. First, it allows system designers to reuse processor independent logic, I/O building blocks, from system to system. In this way, the programmable logic device provides a modular system such that a system designer may simply pick and choose I/O interfaces for the intended purpose of the customizable computer system.

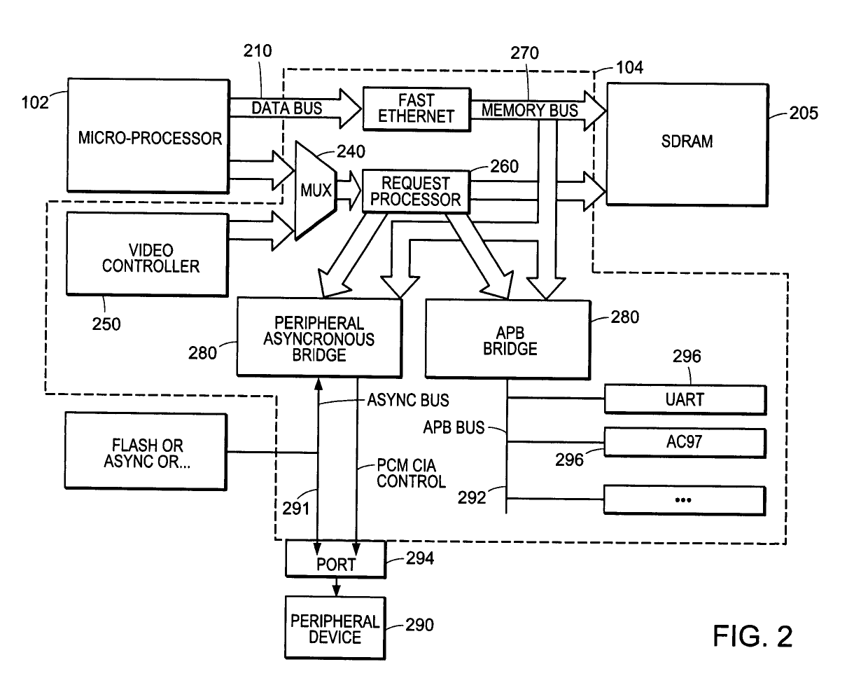

FIG. 2 shows the flow of instructions and data between the microprocessor 102, the programmable logic device 104, and memory 205. The data bus 210 allows data to pass to the programmable logic device from the microprocessor. The data flows into a memory controller and is placed on a memory bus and transferred to the external memory 205, which in the figure is labeled as SDRAM. As opposed to data, instruction signals from the microprocessor are sent on the dedicated bus 103 and pass through a multiplexor 240 that is also coupled to a video controller 250. The multiplexor 240 forwards the instruction signal to a request processor 260. Based upon the type of instruction, the request processor 260 will access memory 205 by sending the instruction on the memory bus 270, or direct the instruction to the bridge 280 for translation and placement of the instruction on a bus for a peripheral device. If the peripheral device 290 is an external device the instruction is sent on the peripheral bus 291 via a port 294. For example, hardware may be implemented for I/O of a peripheral device on the programmable logic device such as those previously mentioned, USB, IEEE1394, PCMCIA etc. The peripheral bus may be a synchronous or an asynchronous bus. If the peripheral is an internal peripheral 296, the instruction is sent to the system on an APB asynchronous bus 292. Internal peripherals 296 may include UART, IRQ Ctrl, AC97 (Audio Controller), GPIO (General Purpose Input/Output), for example.

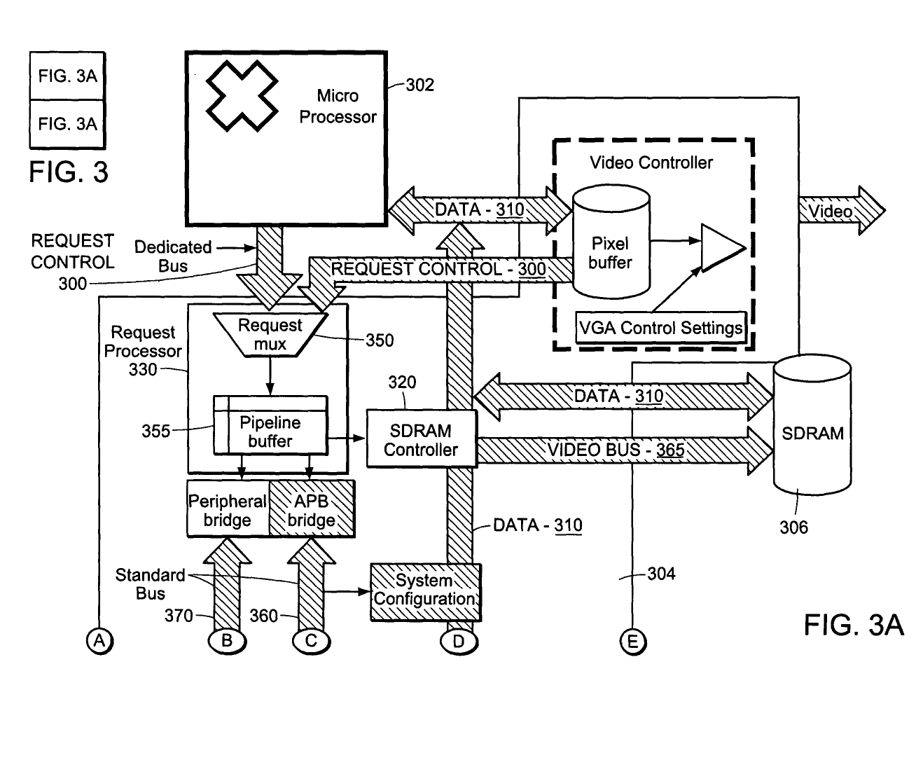

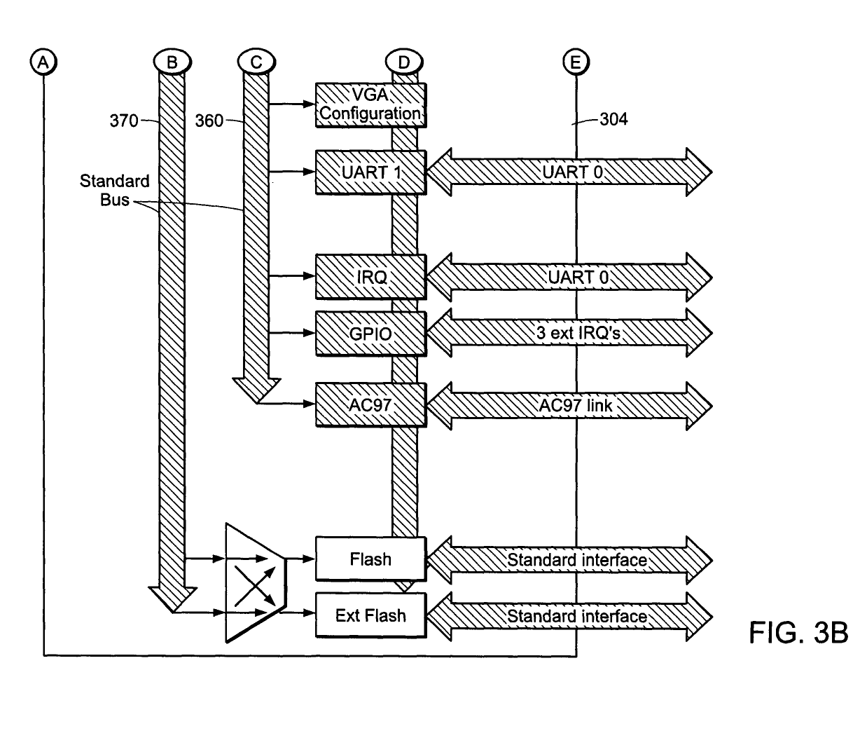

FIG. 3 shows the request (instruction) 300 and data path 310 connections between the microprocessor 302, the memory 306 and the programmable logic device 304. The data bus 310 in one embodiment is 64 datalines and connects the microprocessor 302 to the programmable logic device 304 and the memory 306 via memory controller 320. Depending on the actual request being processed, data runs between the microprocessor 302 and the programmable logic device 304 (access to and from internal and external peripheral devices), the microprocessor 302 and memory 306 (memory access) or memory 306 and the programmable logic device 304 (processed video request). The data bus 310 operates independent from the request bus 300 to allow for pipelined requests. In one embodiment, the microprocessor issues a request which occurs over two timing cycles and which is demultiplexed by the programmable logic device 304. The data bus 310 is under the control of the memory controller 320, which is part of the programmable logic device 304.

The processor specific command and control requests are translated by the programmable logic device 304. The programmable logic device 304 has a request processor 330. The request processor 330 accepts requests 300 from the microprocessor 302, performs a multiplexing function in multiplexor 350, checks to see if there is a concurrent request from the video sub-system of the programmable logic device and then puts the request in a stage buffer 355 which in one embodiment is 5 deep pipeline FIFO buffer.

The request processor 330 adds flags to the request to allow the correct subsystem (memory controller, APB bus, and peripheral bus) to identify the request. In one embodiment, the request is issued by the microprocessor 302 in two cycles wherein the command and the address are provided to the programmable logic device. The programmable logic device reformats the processor specific command including the address. As the first cycle is processed, the request processor 330 indicates if the request is a read or a write and what memory region is being accessed by accessing memory 306. The memory controller 320 starts decoding the memory range if a memory access is requested in order to meet timing requirements while the request is still in the FIFO 355 so that pipelining may be achieved. During the second cycle, the length of the transaction is indicated along with the second section of the memory location. This information is stored in the request processor FIFO 355 along with the decoded address range of the first cycle and the command. The decoded address provides a flag which in the present embodiment is a multi-bit word indicating whether the request is an access for the memory 306, the APB bus 360, the video bus 365, or the peripheral bus 370. This request propagates through the FIFO 355 until it reaches the last position.

As stated above, as the request propagates through the FIFO, the memory controller checks 320 to see if the request is for memory and if so the memory controller checks 320 to see if the memory requested is for an open row/bank.

If the request is to access memory, when the request exits the buffer, the request is sent to the memory controller 320. The memory controller 320 then performs a command sequencing as is understood in the art. At the end of this pipelined operation, the data is available at the memory dataport and the microprocessor is signaled to fetch the requested data. If the request is for access to either the peripheral bus or APB bus, the commands are then translated from the processor specific format in a bridge to a sequence of commands resulting in the right data to be put on the data bus at the right time, such that the processor receives the correct data.

The programmable logic device also includes a video controller. The video controller receives data in the format of the processor via the data bus. The video controller and the microprocessor both share external memory as the video processor does not have a dedicated frame buffer. When in operation, the video controller issues data requests to the memory controller and buffers the pixels in a FIFO to overcome memory latency. Both the microprocessor and the video controller are master devices on the memory request bus. The video controller continuously keeps the FIFO filled by requesting memory access when needed and the FIFO is kept large enough to provide a continuous pixel data stream to the pixel generator of the video controller. It should be clear that the video controller shares the external memory with the processor and uses this external memory as a frame buffer for graphical images.

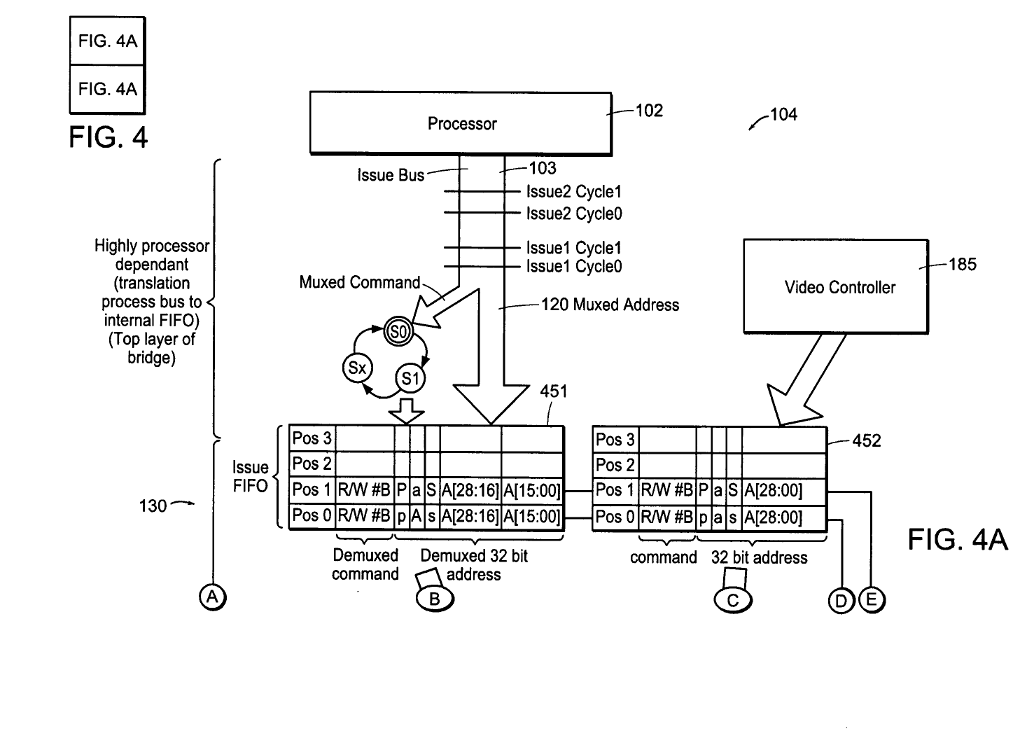

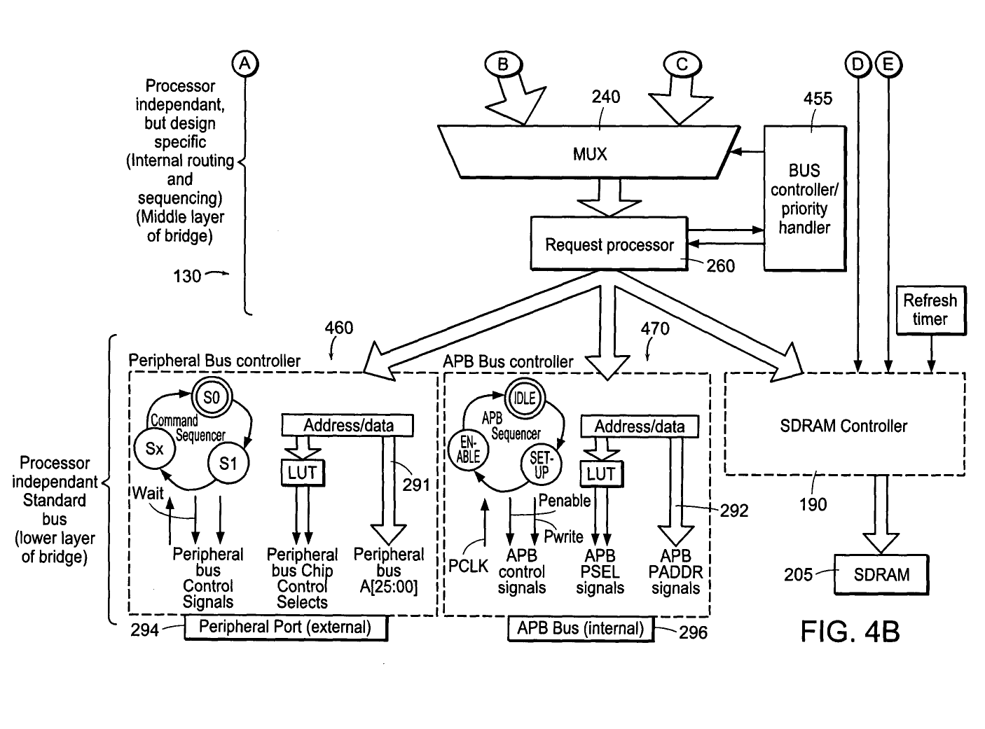

FIG. 4 is a block diagram showing the bridge mechanism 130 and the translation of processor dependent commands to processor independent commands for use on a peripheral bus or an APB bus or accessing memory via the memory controller. In the figure, two requests are sent from processor 102 which are issue 1 and issue 2. These requests are sent over the dedicated bus from the processor 102 and the request includes both a command for either reading or writing along with an address for either reading data from the address or writing data to the address. Each request issue is sent on the dedicated bus 103 over the course of two cycles so that a single request is sent in two sections wherein during cycle 0 the command is sent along with the first part of the address and during cycle 1 the second part of the address is sent. During cycle 1 the first 3 bits include command instructions ADS/Lock/W/R. ADS indicates the start of the address phase and triggers the state machine to accept the upper address bits from the first clock cycle at the same clock time. Lock indicates that this is a locked access as is understood in the art. The final bit W/R indicates whether the command is a read or a write command. This is a processor specific format for an Intel XScale processor for allowing pipelined processing although other processors may transmit commands in different formats. If other processors are used, the programmable logic device would be configured to receive the processor specific commands, convert the commands and the address to an intermediate state and finally pass the commands and address information to an appropriate controller which performs the final conversion of the issue/request from the processor to a processor independent format that can be placed on either a peripheral bus, an APB bus, or a memory bus.

As can be seen within FIFO 451 the address is made up of 32 bits, but 16 bits are sent each cycle. The requests are received by the programmable logic device 104 and are placed into a demultiplexor 420 which reformats the command and the address into an intermediate format that is used by the programmable logic device prior to translating the request/address into a processor independent command that is in either a standard peripheral bus format, APB format or SDRAM format. The demultiplexor along with control logic places the command into FIFO 451 along with the entire corresponding address from cycle 0 and cycle 1. In the preferred embodiment address bits A[31:29] are employed to determine the targeted device. For example if the bits are [000] this code may indicate SDRAM access. If the bits are [010] this code may indicate APB access. It should be understood that the code is a processor dependent code and therefore will depend on the specific processor chosen for implementation. During each cycle a total of 16 address bits are transmitted. The demultiplexor places the address bits [28:00] into the FIFO next to the command and also next to a bit that indicates the target. In the FIFO there are three independent bits that indicate a target, however only one of which can be active at a time. The activation of the particular bit is based upon address bits A[31:29] which as explained before indicate the target. In FIG. 4 these three target bits are indicated as P,A,S (peripheral, APB, or SDRAM).

The final intermediate format is r/w, #B, P, A, S, A [28:00]. The type of command is first presented which indicates whether it is a read or a write, then the number of bits that are either going to be written or read is provided, the bit representing the target is set high (either P, A, or S) and finally the 29 address bits are provided.

In the embodiment shown in FIG. 4, there are two FIFOs 451, 452 that are present and both FIFOs are four levels deep. This differs from previous embodiments. Further, in this embodiment, the FIFOs precede the request processor. FIFO 451 receives processor dependent requests (labeled as issues). The second FIFO 452 processes requests from the video processor. The video processor passes the request through FIFO 452 and the request is translated into an intermediate format in a similar fashion to the issue/request from the processor. It should be recognized that FIG. 4 does not show the data bus. The video processor sends data that has been processed to SDRAM memory for frame buffering prior to the data being provided to a graphical device for display.

Every two cycles the issue FIFO 451 can be passed another request. As the request is passed through the FIFO and reaches pos. 1 and pos. 0 within the FIFO the SDRAM controller 190 checks to see if memory is being accessed and if so what the address is and begins to prepare the addresses for either a read or a write so that pipelined processing may be accomplished. When the issue reaches the end of the FIFO, it is passed to another multiplexor 240 which is coupled to a bus controller/priority handler 455. The priority handler 455 checks the FIFOs 451 and 452 to see if the next command is a video request, the priority handler gives preference to the video request over the issue requests from the processor 102. The request processor 260 then reads the first three bits of information from the request and determines the proper controller to pass the request to. The request can be passed to either the peripheral bus controller 460, the APB bus controller 470 or to the SDRAM controller 190 depending on whether an external peripheral is being accessed, an internal peripheral is being accessed or memory is being accessed. The appropriate bus controller further translates the intermediate command and address format to the appropriate format of the bus which is then completely processor independent. First, the command is accepted by the appropriate controller and the controller splits the command by address subrange and by device select signals. The appropriate device select signal is determined using a look-up table based upon the command. The bus controller also contains a state machine that controls the signal state (S0, S1 . . . ). Based upon the signal state commands are placed onto the bus at the appropriate times. The result is a bus standard set of signals.

For example, for the APB bus controller, the bus operates in an asynchronous mode and there are three bus states which are idle, setup, and enable. The APB bus controller decodes address bits A [28:24] by comparing these bits with a look-up table (LUT). This LUT defines which device is selected based on a list of predefined address ranges. For example, if the address bits are [0, 0, 0, 0, 1] this sequence represents address 0×41000000 which will select UART0. It should be understood that the address sequence is processor dependent and therefore will change from embodiment to embodiment depending on the processor that is selected. Selecting the device is accomplished by activating the UART0's corresponding PSEL signal as is understood by those skilled in the art. Further explanation of the appropriate signaling sequence of an AMBA APB bus may be found in the AMBA specification Rev. 2.0 (1999) which is incorporated herein by reference in its entirety. The R/W signal is used to set the APB Pwrite signal. The least significant address lines A [15:00] are passed onto the APB bus for the peripheral device to internally decode. The foregoing is accomplished during the Setup phase of the APB bus controller. During the next time period, which is the Enable phase, the data is either read or written by the selected peripheral. In the current embodiment, APB devices only allow a 4 byte access and thus the #B sequence from the intermediate format is set to 010. In the case of the SDRAM or peripheral bus this restriction does not apply, and the state machine will use the #B to control the right number of accessed bits on the peripheral device.

In contrast to the asynchronous APB bus, the peripheral bus may be a bus synchronous and may be a bus such as a PC ISA bus. The state machine of the peripheral bus controller is a command sequencer. Since the bus is synchronous the command sequencer may receive a wait state from the peripheral device which causes the peripheral bus controller to hold and not transmit additional instructions until the peripheral device has completed the read or write request. For the peripheral bus, address bits A[25:00] are passed to the bus. The peripheral bus controller also has a LUT which performs a similar function to the LUT of the APB bus controller selecting the appropriate peripheral device based on address bits from the intermediate format and sending an appropriate peripheral bus chip select signal to the peripheral bus to access the desired peripheral device.

Because of the described configuration, a microprocessor can be coupled to the programmable logic device and the programmable logic device can be reconfigured to provide additional I/O functionality wherein the I/O functionality can be pre-designed since all processor specific commands are translated into processor independent commands. As such, pre-designed I/O modules that interface with either a peripheral bus or with an APB bus may be made and then readily coupled to a processor, thus speeding up the time for designing an embedded system while at the same time providing similar performance to that of a system on a chip or ASIC design.

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A customizable computing system, the system comprising:
a microprocessor;
a programmable logic device coupled to the microprocessor via a dedicated bus, and wherein the programmable logic device includes a configuration to provide I/O functionality to the system and includes one or more I/O interfaces; and
a system port coupled to the programmable logic device.

2. A system according to claim 1, further comprising a second bus coupled to the programmable logic device, wherein the system port is coupled to the second bus.

3. A system according to claim 1, further comprising a plurality of ports coupled to the programmable logic device.

4. A system according to claim 2, further comprising a plurality of ports coupled to the second bus.

5. A system according claim 1, wherein the programmable logic device includes a configuration to serve as a bridge between the dedicated bus and the system port.

6. A system according 2, wherein the programmable logic device includes a configuration to serve as a bridge between the dedicated bus and the second bus.

7. A system according to claim 1, wherein the microprocessor is a specific type and the programmable logic device includes a includes a configuration that provides functionality specific for the specific type of microprocessor.

8. A system according to claim 1, wherein the microprocessor is a specific type and the programmable logic device includes a includes a configuration that provides functionality that is independent of the specific type of microprocessor.

9. A system according to claim 8, wherein the microprocessor is a specific type and the programmable logic device includes a includes a configuration that provides functionality that is dependent on the specific type of microprocessor.

10. A system according to claim 9, wherein the programmable logic device includes a configuration to serve as a bridge between the functionality that that is independent of the specific type of microprocessor and the functionality that is specific for the specific type of microprocessor.

11. A system according to claim 1, wherein the programmable logic device is a field programmable gate array.

12. A system according to claim 1, wherein the microprocessor is of a type employing a RISC instruction set, such instruction set being at least 32 bits wide.

13. A system according to claim 1, wherein the microprocessor and the programmable logic device are integrated in the same physical package.

14. A system according to claim 1, wherein the dedicated bus includes a data path that is 64 bits wide.

15. A system according to claim 1, wherein the microprocessor has an architecture permitting pipeline processing of at least four simultaneously outstanding operations and the dedicated bus and programmable logic device are configured to support such pipeline processing.

16. A system according to claim 1, further comprising random access memory of at least 64 megabytes coupled to the microprocessor and wherein the microprocessor is of a type permitting operation of at least 500 MIPS and the system has a fully operational performance-to-power ratio of at least 300 MIPS per watt.

17. A system according to claim 12, wherein the microprocessor utilizes ARM architecture.

18. A system according to claim 17, wherein the microprocessor provides performance at least equal to that of an Intel Xscale 80200 model microprocessor.

19. A system according to claim 1, wherein the programmable logic device includes a configuration to provide a hardware video display driver.

20. A system according to claim 19, the system further includes random access memory coupled to the microprocessor and the video display driver shares the memory with the microprocessor.

21. A system according to claim 1, the system further includes random access memory coupled to the microprocessor and accessible over the dedicated bus.

22. A system according to claim 20, wherein the random access memory is accessible over the dedicated bus.
